(19) United States
(12) Patent Application Publication
(10) Pub. No.: US 2025/0384238 A1
(43) Pub. Date: Dec. 18, 2025

(54) JOINT CHANNEL, LAYER, AND BLOCK PRUNING FOR NEURAL NETWORKS ACCORDING TO LATENCY CONSTRAINTS

(71) Applicant: NVIDIA Corporation, Santa Clara, CA (US)

(72) Inventors: Xinglong SUN, San Jose, CA (US); Barath LAKSHMANAN, Gilbert, AZ (US); Maying SHEN, Fremont, CA (US); Shiyi LAN, San Jose, CA (US); Jingde CHEN, San Jose, CA (US); Jose Manuel ALVAREZ LOPEZ, Mountain View, CA (US)

(73) Assignee: NVIDIA Corporation, Santa Clara, CA (US)

(21) Appl. No.: 18/745,316

(22) Filed: Jun. 17, 2024

(51) Int. Cl. G06N 3/04

(52) U.S. Cl. CPC G06N 3/04

(57) ABSTRACT

In various examples, systems and methods are disclosed relating to jointly pruning channels, layers, and/or blocks of neural networks according to target latency constraints. One or more circuits can determine a plurality of importance scores for a plurality of layers of a neural network and can generate a latency cost data structure for the neural network. The one or more circuits can prune the neural network based at least on the plurality of importance scores, the latency cost data structure, and a target latency value.

### BACKGROUND

Deep neural networks include large numbers of parameters (e.g., weights and biases), making them challenging to deploy on resource-constrained systems. Neural network pruning is a technique used to reduce the size of a neural network by removing certain parameters that are deemed less important or redundant. However, excessive or improper pruning can lead to a significant drop in accuracy as important connections might be removed.

### SUMMARY

Embodiments of the present disclosure relate to techniques for performing joint channel, layer, and/or block pruning for neural networks according to latency constraints of target environments. The present disclosure provides improvements over conventional approaches for neural network pruning. Conventional approaches for pruning neural networks are only capable of achieving 30%-40% reduction in parameters. However, achieving target latency on certain target environments for executing neural network models require a further reduction in parameter count-ranging from 60%-90%-which is impossible with conventional pruning techniques without significantly reducing the accuracy of the neural network.

The systems and methods described herein improve upon conventional pruning techniques by implementing joint channel, layer, and/or block pruning of neural network models according to configurable latency targets. By pruning blocks of neural networks in addition to layer and channel pruning, the techniques described herein can achieve 60%-90% pruning of neural network parameters while maintaining accuracy and target latency requirements of a target deployment environment. By pruning according to a mixed-integer nonlinear program (MINLP), the techniques described herein can efficiently determine an optimal pruned structure of a neural network in a single forward pass.

At least one aspect relates to one or more processors. The one or more processors can include one or more circuits. The one or more circuits can determine a plurality of importance scores for a plurality of layers of a neural network. The one or more circuits can generate a latency cost data structure (e.g., latency cost matrix) for the neural network. The one or more circuits can prune the neural network based at least on the plurality of importance scores, the latency cost data structure, and a target latency value.

In some implementations, the one or more circuits can extract a subnetwork from the neural network based at least on the plurality of importance scores and the latency cost data structure. In some implementations, the one or more circuits can generate a pruned neural network by updating the subnetwork using a training dataset. In some implementations, the one or more circuits can identify at least one block of a subset of the plurality of layers of the neural network. In some implementations, the one or more circuits can prune the at least one block from the neural network based at least on the plurality of importance scores and the latency cost data structure.

In some implementations, the one or more circuits can identify at least one channel of at least one layer of the plurality of layers of the neural network. In some implementations, the one or more circuits can prune the at least one channel from the neural network based at least on the plurality of importance scores and the latency cost data structure. In some implementations, the one or more circuits can identify the subset of the plurality of layers based at least on a skip connection of the neural network.

In some implementations, the one or more circuits can generate a respective set of channel importance scores for each layer of the plurality of layers. In some implementations, the one or more circuits can generate the plurality of importance scores based at least on the respective set of channel importance scores for each layer of the plurality of layers. In some implementations, the one or more circuits can determine a respective latency of each channel of a layer of the plurality of layers.

In some implementations, the one or more circuits can generate the latency cost data structure based at least on the respective latency of each channel. In some implementations, the one or more circuits can identify one or more layers or one or more blocks of the neural network to prune using a mixed-integer non-linear programming (MINLP) optimization function. In some implementations, the one or more circuits can assign each of the one or more layers and the one or more blocks to a respective variable for the MINLP optimization function.

Another aspect relates to a system. The system can include one or more processors. The system can identify a neural network comprising a plurality of channels, a plurality of layers, and a plurality of blocks. The system can extract, from the neural network, a subnetwork by jointly pruning at least one block, channel, and layer of the neural network according to a latency constraint. The system can update the subnetwork according to a dataset associated with the neural network.

In some implementations, the system can determine the latency constraint based at least on a computing environment in which the subnetwork is to be deployed. In some implementations, the system can transmit the subnetwork to the computing environment. In some implementations, the dataset comprises one or more training examples used to update the neural network. In some implementations, the system can prune the neural network using a MINLP optimization function. In some implementations, the system can identify the at least one block based on a skip connection of the neural network. In some implementations, the system can generate a plurality of importance scores for at least the plurality of channels of the neural network. In some implementations, the system can prune the neural network further based on the plurality of importance scores.

Yet another aspect of the present disclosure is related to a computing device. The computing device can include one or more processors. The computing device can identify a processing operation corresponding to a neural network. The computing device can perform the processing operation using a subnetwork, the subnetwork having been extracted from the neural network according to a joint channel, layer, and block pruning process.

In some implementations, the computing device can generate a plurality of latency values for at least a subset of layers of the neural network. In some implementations, the computing device can generate a lookup table according to the plurality of latency values, wherein the subnetwork is extracted based at least on the lookup table.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations, a system implemented using at least one language model—such as one or more large language models (LLMs) and/or one or more vision language models (VLMs), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for generative techniques for joint channel, layer, and block pruning for neural networks according to latency constraints are described in detail below with reference to the attached drawing figures, wherein:

FIG. 1 is a block diagram of an example system that implements joint channel, layer, and/or block pruning for neural networks according to latency constraints, in accordance with some embodiments of the present disclosure;

FIG. 2 illustrates an example dataflow diagram showing how pruning is jointly performed at the channel, layer, and/or block level of a neural network, in accordance with some embodiments of the present disclosure;

FIG. 3 is a flow diagram of an example of a method for implementing joint channel, layer, and/or block pruning for neural networks according to latency constraints, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for performing multi-dimensional pruning for neural networks. The techniques described herein can be used to implement joint channel, layer, and/or block pruning according to specified latency constraints, allowing for configurable pruning outcomes for pruning neural networks while optimizing/adjusting for neural network performance. Such techniques can be useful for larger neural networks that are to be deployed on resource-constrained edge devices without incurring significant accuracy loss.

Conventional approaches for implementing neural networks on edge devices involve either retraining a model with reduced size, which incurs significant computational costs for retraining, or using pruning to distill a smaller model from a larger model. Although pruning techniques can be used to reduce parameter count, traditional approaches cannot prune aggressively enough to meet the resource constraints of edge devices. For example, traditional approaches can reduce the size of neural networks by 30%-50%, but often result in suboptimal accuracy.

One reason for these drawbacks is that current pruning approaches to directly reduce inference latency use latency models that only account for variations in output channel count at each layer, ignoring the simultaneous impact of pruning on input channels. This inaccurate latency estimation leads to suboptimal trade-offs between accuracy and latency, especially at larger pruning ratios. Reducing model size by 30%-50% still results in unacceptable latency at some edge devices, particularly when in real-time or near real-time environments, requiring larger pruning ratios of 70%-90%. Particularly for deep neural networks, achieving a pruning radio of 70%-90% for a given latency target often requires complete removal of certain layers or blocks of the neural network, which is not possible using conventional pruning techniques.

To address these limitations, the systems and methods described herein provide techniques for implementing joint channel, layer, and/or block pruning of neural networks, while optimizing for latency of a target device. To do so, a joint latency modeling technique is implemented that accurately captures model-wide latency variations during pruning, which can achieve an optimal latency-accuracy trade-off even at high pruning ratios. Rather than using conventional approaches that independently model channel, layer, and block pruning, the techniques described herein jointly model simultaneous channel, layer, and/or block pruning to achieve large pruning ratios according to desired latency targets.

The pruning techniques described herein can include using computing layer importance and constructing latency cost matrices for each layer in a neural network. The layers are then grouped within a same block, and a mixed integer nonlinear program is solved to optimize pruning decisions at both channel and block levels. The pruned subnetwork is then extracted from the neural network and finetuned to ensure model accuracy and performance.

Unlike conventional approaches, the techniques described herein can be used to simultaneously prune multiple dimensions of a neural network topology and automatically create a new architecture that performs faster with reasonable accuracy variability. The joint pruning techniques produce superior results compared to existing pruning methods. More specifically, compared to existing approaches, the techniques described herein outperform conventional pruning techniques in terms of both accuracy and speed.

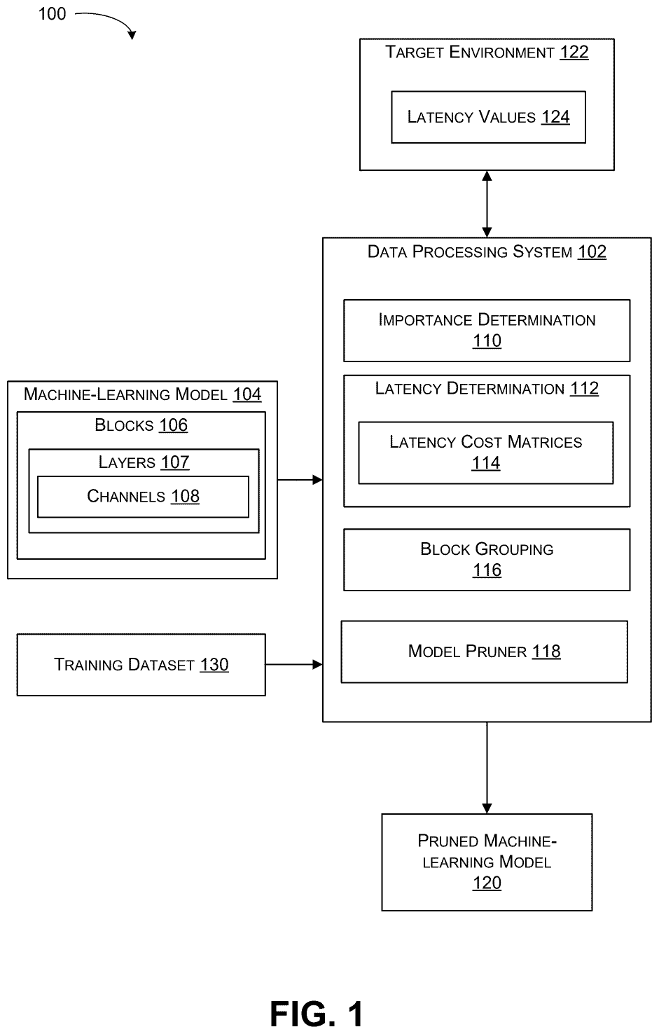

FIG. 1 is an example computing environment including a system 100 that implements joint channel, layer, and block pruning for neural networks according to latency constraints, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., neural network), operation, routine, logic, or instructions to perform various functionality described herein.

The system 100 is shown as including the data processing system 102, a machine-learning model 104, a pruned machine-learning model 120, and a target environment 122. The data processing system 102, or the components thereof, can access the machine-learning model 104 to jointly prune channels 108, layers 107, and/or blocks 106 from the machine-learning model 104 to generate the pruned machine-learning model 120 according to a target latency for the target environment 122. The machine-learning model 104 may be maintained via an external server, distributed storage/computing environment (e.g., a cloud storage system), or may be stored via memory of the data processing system 102.

The machine-learning model 104 may be any type of neural network, including deep convolutional neural networks used for image/sensor data (e.g., LiDAR, RADAR, ultrasonic, etc.) classification, segmentation, or object/feature detection, among other machine-learning tasks. In other embodiments, the machine learning model 104 may include a generative machine learning model-such as a transformer based neural network. In some embodiments, the machine learning model 104 may include a language model-such as a large language model, a vision language model, a multi-modal language model, a diarization model, a translation model, an automatic speech recognition (ASR) model, a text to speech (TTS) model, a speech to text (STT) model, among others. As such, the machine learning model 104 is not limited to any type or architecture of model, and is not limited to any particular task or domain.

The machine-learning model 104 is shown as including one or more blocks 106, layers 107, and channels 108. Each block 106 of the machine-learning model 104 may include a residual block, which may include a sequence of one or more layers 107 with a skip connection that bypasses the sequence of layers 107 in the block. Blocks 106 of the neural network may include any type of machine-learning block having a skip connection, including but not limited to convolutional blocks, residual blocks, fully connected blocks, or recurrent blocks, among others. Each type of block 106 may include any type of machine-learning layer.

Layers 107 of the machine-learning model 104 can include any type of machine-learning layer, including but not limited to one or more convolutional layers, fully connected layers, pooling layers, recurrent layers, attention layers, normalization layers, dropout layers, activation layers, embedding layers, residual layers, encoder layers, decoder layers, or combinations thereof, among others. As shown, in some implementations, one or more convolutional layers may include one or more channels 108.

Channels 108 of a convolutional layer 107 may refer to the depth of feature representation within each layer 107 and can each include a respective convolutional filter for processing data generated from the previous layer(s) 107 in the machine-learning model 104. Each convolutional filter of each channel can include a set of parameters (e.g., weights and/or biases) that are updated/trained during a training process for the machine-learning model. Other types of machine-learning layers 107 can one or more sets of parameters. For example, a fully connected layer can include a set of weight values and/or bias values corresponding to a set of neurons of the fully connected layer.

In performing the pruning techniques described herein, the data processing system 102 can jointly prune one or more blocks 106, layers 107, and/or channels 108 from the machine-learning model 104 to generate the pruned machine-learning model 120. Pruning can be performed to optimize to a target latency of the target computing environment 122. To perform pruning according to the techniques described herein, the data processing system 102 can identify the machine-learning model 104, for example, in response to a request to perform model pruning (e.g., from an external computing system) or via input to the data processing system 102. The machine-learning model 104 may be identified in one or more configuration settings stored at the data processing system 102 or may be provided to the data processing system 102 via a corresponding application programming interface (API) call. In some implementations, the data processing system 102 can receive an identifier of the machine-learning model 104 and can retrieve the identified data from one or more external or internal storage systems using the identifier(s).

The data processing system 102 can begin the pruning process by computing layer importance using an importance determination process 110. Latency cost matrices 114 can be generated for each layer using the latency determination process 112, which can use latency values 124 derived at the target computing environment 122. Layers 107 can then be grouped within the same block using the block grouping process 116, and the model pruner 118 can solve an MINLP or similar function to optimize pruning decisions at the block 106, layer 107, and channel 108 levels. The model pruner 118 can extract a subnetwork from the machine-learning model 104 according to the optimized pruning decisions to generate the pruned machine-learning model 120. The data processing system 102 can update/fine-tune the pruned machine-learning model 120, and can subsequently deploy the pruned machine-learning model 120 to the target computing environment 122 for execution.

Once the machine-learning model 104 has been identified for pruning, the data processing system 102 can perform an importance determination process 110 to determine importance scores for one or more channels 108 and/or layers 107 of the machine-learning model 104. In the following example, the machine-learning model 104 is a convolutional neural network. Convolutional parameters of the machine-learning model 104 in this example are referred to as:

$$Θ = {{⋃}_{l = 1}}^{L} {Θ}_{l} , \\ S . T . \\ {Θ}_{l} ∈ {ℝ}^{{m}_{l} \times {m}_{l - 1} \times {K}_{l} \times {K}_{l}}$$

In the above equations, mₗ, mₗ₋₁, and Kₗ denote the number of output channels 108, input channels, and kernel size at each layer 107, which is referred to as l. The neural network of the machine-learning model 104 is referred to as Θ. An input channel for a given layer 107 refers to the number of separate feature maps that are received by the layer 107 (e.g., from a previous layer 107 in the machine-learning model 104). Output channels 108 of a given layer 107 correspond to the number of kernels of the layer 107 that are applied to the one or more input channels during a convolution operation.

The pruning process implemented by the data processing system 102 can be performed by generating pruning decisions by jointly optimizing the best selection of channels 108, layers 107, and/or blocks 106 of the machine-learning model 104 to prune according to a target inference latency (sometimes referred to as “target latency,” and sometimes designated herein as Ψ) of the target environment 122. In some implementations, the target latency may be specified as a function of the computing resources of the target environment 122. In some implementations, the target latency may be provided in a request to perform pruning of the machine-learning model 104 (e.g., from an external computing system, via an API call, etc.), in configuration settings stored at the data processing system 102, and/or via operator input to the data processing system 102.

In the following example implementation, the total number of blocks 106 in the machine-learning model 104 to be pruned is referred to as B. The pruned machine-learning model 120 (e.g., the subnetwork to be extracted from the neural network Θ of the machine-learning model 104 is referred to as \hat{Θ}∈Θ). The goal of the pruning process implemented by the data processing system can be defined such that the inference latency of Θ is less than the target inference latency Ψ. In referring to various operations of the pruning process, the function β(l)∈[1, B] is a function that maps a layer 107 (referred to as l) to a corresponding identifier of the block 106 to which it belongs. A layer channel variable [symbol] ₗ for the pruning process can be defined as a one hot vector [symbol] ₗ∈{0,1}^{m}^{ₗ}. The layer channel variable

$${𝓎}_{l}^{i} = 1$$

if the lth layer 107 is to keep i out of mₗ channels 108. A block decision variable [symbol] _{b} for the pruning process can be defined as [symbol] _{b}∈{0,1}, b∈[1, B]. The block decision variable [symbol] _{b} can be set to [symbol] _{b}=0 if the entire bth block 106 is to be pruned by the pruning process.

In this example, the layer channel variable [symbol] ₗ can be defined as a one-hot vector where the index of the hot bit represents the total number of selected channels in the pruned machine-learning model 120, ranging from 1 to mₗ. Additionally, when a bth block 106 is marked to be pruned (e.g., having [symbol] _{b}=0), all the layers 107 in the block (e.g., β(l)=b) are removed, regardless of the value of the layer channel variable [symbol] ₗ. In this example, this means the number of channels 108 in the corresponding layers 107 (e.g., chancel count) is set to zero. Each of the layer channel variable [symbol] and the block decision variable [symbol] describe the pruning decisions and encoded the pruned machine-learning model 120 (referred to herein as \hat{Θ}). The layer channel variable [symbol] and the block decision variable [symbol] are targets that are jointly optimized according to the techniques described herein to achieve pruning according to the target latency of the target environment 122.

Once the data processing system 102 has initiated the pruning process, the data processing system can execute an importance determination process 110 to determine importance scores for one or more channels 108 and/or one or more layers 107 of the machine-learning model 104. The importance scores are leveraged as a proxy for the performance of the pruned machine-learning model 120. The optimal subnetwork \hat{Θ} of the machine-learning model 104 is one that maximizes the importance score while closely adhering to the target latency constraint Ψ of the target environment 122.

To achieve large latency reduction relative to the original machine-learning model 104, the data processing system 102 can jointly remove layers 107 and/or blocks 106 from the machine-learning model 104 guided by accurate latency estimations. To do so, the importance determination process 110 can determine importance scores for different values of the layer channel variable [symbol] . Accurate latency estimations are determined for these varying configurations, for each individual layer, by the latency determination process 112. The latency determination process 112 can aggregate these components across all layers of the machine-learning model 104. The block grouping process 116 can combine layer 107 and block 106 removal with channel sparsity by grouping the latency and importance expression for all layers within the same block 106 under a single block decision variable. The model pruner 118 solves a MINLP to jointly determine the layer channel variable [symbol] and the block decision variable [symbol] for a pruned subnetwork \hat{Θ} of the machine-learning model 104 at both the channel 108 and block 106 levels. The model pruner 118 extracts the pruned subnetwork \hat{Θ} from the machine-learning model 104 to generate the pruned machine-learning model 120, as a function of the solved layer channel variable [symbol] and the solved block decision variable [symbol] .

The importance determination process 110 can be performed to calculate importance scores for each channel 108 in each layer 107 of the machine-learning model 104. The importance scores can be, in some implementations, Taylor importance scores or magnitude-based importance scores, among others. In one example using Taylor importance scores, the importance determination process 110 can be performed to calculate an importance score [symbol] for the jth channel 108 of the lth layer 107 of the machine-learning model 104 using the following equation:

$${l}_{j}^{} = \vert {g}_{{γ}_{l}^{j}} {γ}_{l}^{j} + {g}_{{β}_{l}^{j}} {β}_{l}^{j} \vert$$

In the above equation, γ and β are the batch normalization (BatchNorm) weight and bias of the corresponding channel 108. The values g_{γ} and g_{β} refer to the gradients of the loss function with respect to the BatchNorm parameters γ and β.

As the number of channels 108 of the lth layer 107 of the machine-learning model 104 is directly encoded by the one-hot layer channel variable [symbol] ₗ, a respective importance score can be associated with each possible configuration of the layer channel variable [symbol] ₗ, with the one-hot bit index ranging from 1 to mₗ. Computing the importance score for the lth layer 107 of the machine-learning model 104 can be a function of the importance scores of each channel 108 of the layer 107. For example, if the lth layer 107 of the machine-learning model 104 is to keep i channels 108 (e.g.,

$${𝓎}_{l}^{i} = 1 ) ,$$

the i channels 108 retained in the pruned machine-learning model 120 can be selected as the top-i most importance channels 108 in the layer 107. To determine a layer importance score

$${{ˆ}^{}}_{l}^{i}$$

for the lth layer 107 corresponding to [symbol] ₗ with

$${𝓎}_{l}^{i} = 1 ,$$

the importance determination process 110 can aggregate the i highest channel importance scores calculated as described herein. The layer importance score

$${{ˆ}^{}}_{l}^{i}$$

for the lth layer 107 corresponding to [symbol] ₗ with

$${𝓎}_{l}^{i} = 1$$

can be calculated according to the following equation:

$${{ˆ}^{}}_{l}^{i} = \sum TopK ( {l}_{} , i ) , ∀ i ∈ [ 1 , {m}_{l} ]$$

In the above equation, the vector [symbol] ₗ∈ [symbol] can fully describe the importance scores for all possible number of channels 108 present in the lth layer 107 from 1 to mₗ. The TopK function selects the top i highest channel importance scores. Using these values, the overall importance of the lth layer 107 of the machine-learning model 104 can be expressed as the following dot product: [symbol] ₗ^{T}. [symbol] ₗ.

The importance determination process 110 can calculate the importance scores for each layer according to these equations by providing one or more training/update samples of a training dataset 130 corresponding to the machine-learning model 104 using both forward and backward passes through the machine-learning model 104. The training dataset 130 may be specified in the request to prune the machine-learning model 104, via operator input to the data processing system 102, or may be specified in stored configuration settings of the data processing system 102 and/or the machine-learning model 104. The data processing system 102 can access the training dataset 130 to identify or otherwise retrieve one or more training/update samples, each of which can include respective input data and corresponding ground truth data. In an example where the machine-learning model 104 is a classification model, the training/update examples of the training dataset 130 can include images as input data and corresponding classification labels as ground truth output data.

The importance determination process 110 can execute the machine-learning model 104 in a forward pass and backward pass (e.g., backpropagating error to determine loss gradients) to calculate the channel importance

$${l}_{j}^{}$$

for each channel of each layer 107 of the machine-learning model 104. In some implementations, the layer importance scores [symbol] , for each layer 107 of the machine-learning model 104 can be calculated by accumulating the layer importance scores for one epoch of the training dataset 130 (e.g., each training/update example provided in forward/backward propagation through the machine-learning model 104 once). In some implementations, a fraction of the training dataset 130 may be used by the importance determination process 110 to determine the layer importance scores [symbol] ₗ for each layer 107 of the machine-learning model 104.

The data processing system 102 can execute the latency determination process 112 to generate a set of latency cost matrices 114 for the layers 107 of the machine-learning model 104. To accurately guide pruning according to the target latency of the target computing environment 122, the latency determination process 112 can determine latency variations of each layer 107 with respect to both the number of input and output channels of the layer 107. A latency cost matrix 114 (sometimes referred to as Cₗ) can be generated for each layer 107 l of the machine-learning model 104. The latency cost matrix for the lth layer 107 of the machine-learning model 104 can be expressed according to the following equation:

$${C}_{l} = [ \begin{matrix}{T}_{l} ( 1 , 1 ) & {T}_{l} ( 1 , 2 ) & ⋯ & {T}_{l} ( 1 , {m}_{l} ) \\ {T}_{l} ( 2 , 1 ) & {T}_{l} ( 2 , 2 ) & ⋯ & {T}_{l} ( 2 , {m}_{l} ) \\ ⋮ & ⋮ & ⋱ & ⋮ \\ {T}_{l} ( {m}_{l - 1} , 1 ) & {T}_{l} ( {m}_{l - 1} , 2 ) & ⋯ & {T}_{l} ( {m}_{l - 1} , {m}_{l} )\end{matrix} ]$$

In the above equation, the values of Tₗ can refer to a latency lookup table generated according to latency values 124 measured at the target computing environment 122. In some implementations, the data processing system 102 can communicate with the target computing environment 122 via one or more communication interfaces to determine latency values 124 for each combination of input and output channels 108 of the machine-learning model 104. In the lookup table values Tₗ(X, Y), the first value (e.g., X) refers to the number of input channels in the corresponding layer 107 and the second value (e.g., Y) refers to the number of output channels in the corresponding layer 107. Each value of Tₗ can be a corresponding latency value 124 generated at the target computing environment 122.

To generate the latency values 124, the target computing environment 122 can execute at least the operations of the corresponding layer 107 of the machine-learning model 104 using one or more input examples (e.g., from the training dataset 130, a randomly generated or predetermined input, etc.). The number of input channels of the layer 107 being measure can be iteratively modified by providing a corresponding set of input channel data (e.g., feature maps, etc.) to the layer. For each set of input channel data (e.g., according to a given number of input channels per iteration), the number of filters used can be iteratively generate a corresponding set of output filters, measuring a latency value for each output filter iteration. The measured latency to generate the number of output channels Y for a given number of input channels X can be provided as the latency value 124 for storage in the lookup table as Tₗ(X, Y).

The target computing environment 122 can iterate through each combination of input channels from 1 to mₗ₋₁ and output channels from 1 to mₗ for each layer of the machine-learning model 104 to determine the latency values 124 for each combination of input/output channels. In some implementations, the latency values 124 can be calculated as average latency for each combination of input/output channels across multiple training/update examples of the training dataset 130 (or randomly generated input channels, in some implementations). The latency values 124 can be generated, for example, using one or more profiling functions executed at the target computing environment 122. The calculated latency values 124 can be transmitted or otherwise communicated to the data processing system 102 for storage in a respective latency cost matrix 114 for each layer 107 of the machine-learning model 104.

The latency cost matrix 114 Cₗ for the lth layer 107 enumerates the latency corresponding to all possible pruned configurations of the lth layer 107. These configurations can be encoded in the one-hot layer channel variables [symbol] ₗ₋₁ and [symbol] ₗ, and therefore a bilayer configuration latency expression can be defined as two dot-products: [symbol] ₗ·( [symbol] ₗ₋₁^{T}·Cₗ). Defining a bilayer configuration latency expression in this manner enables the model pruner 118 to optimize pruning with more precise latency estimations, which is a significant improvement compared to conventional pruning techniques that do not consider simultaneous contributions from both input and output channel variation.

The block grouping process 116 can be used to group layers 107 into blocks 106, such that pruning of the machine-learning model 104 may occur at the block level. As described herein, the layer channel variables [symbol] ₗ describe the channel 108 count from 1 to mₗ in the lth layer 107, excluding the case when pruning removes all channels from the lth layer 107. This is because arbitrarily pruning a single layer can lead to neural network disconnection, causing discontinuity in the flow of information through the machine-learning model 104. Residual blocks 106 are inherently resilient to removal of all their internal layers at once, as the skip connection defining the residual blocks 106 allows information to bypass the removed layers, preserving gradient flow.

To enable removal of entire blocks 106 of the machine-learning model 104, the block grouping process 116 can be used to parse the network architecture of the machine-learning model 104 to obtain a block mapping β(l) for every layer 107 l of the machine-learning model 104. Identifying the identifier of the block 106 to which a layer corresponds can be performed by assigning a respective block identifier to each skip connection in the machine-learning model. The block grouping process 116 can then iterate through each layer 107 in the machine-learning model 104 to determine whether the layer 107 is surrounded by a skip connection. If the layer 107 is surrounded by a skip connection, the block grouping process 116 can assign a block identifier to the layer 107 according to the corresponding skip connection. Multiple layers 107 may be assigned the same block 106 identifier.

All importance and latency expressions described herein can be grouped under a single block decision variable [symbol] . If the optimization process implemented by the model pruner 118 determines that the block decision variable z; for the bth block 106 is to be pruned (e.g., [symbol] _{b}=0), the importance and latency contributions from all layers within that block, where β(l)=b, can be set to zero. As described herein, the group decision can be modeled with the binary block decision variables [symbol] _{b}.

During pruning, for each layer 107 l, the model pruner 118 determines whether its associated block decision variable, denoted [symbol] _{β(l)}, is active (e.g., [symbol] _{β(l)}=1). The layer importance and latency expressions determined by [symbol] for that layer 107 are evaluated only if the block decision variable is active. The importance for the lth layer 107 of the machine-learning model 104 is therefore a function of [symbol] ₗ and [symbol] _{β(l)}. The importance for the lth layer 107 of the machine-learning model 104 can be expressed as [symbol] _{β(l)}·( [symbol] ₗ^{T}· [symbol] ₗ). The bilayer configuration latency at the lth layer 107 of the machine-learning model 104 can be expressed as [symbol] _{β(l)}·( [symbol] ₗ·( [symbol] ₗ₋₁^{T}·Cₗ)). According to these expressions, the block decision variables z have a greater priority than the layer channel variables [symbol] . For example, deactivating 21 results in the exclusion of all layers 107 within the first block 106 (e.g., where β(l)=1) by setting their importance and latency expressions to zero, regardless of the values of the layer decision variables [symbol] ₗ. For layers 107 that do not belong to blocks 106, corresponding [symbol] values can always be set to one, such that those layers 107 are not removed from the machine-learning model 104.

The model pruner 118 can jointly determine the optimal layer channel and block decision variables [symbol] and [symbol] that maximize the summation of their importance scores while ensuring the cumulative bilayer configuration latency remains below the target latency constraint Ψ of the target environment 122. To do so, the model pruner 118 can solve a MINLP function corresponding to the layer channel and block decision variables [symbol] and [symbol] . The MINLP function can be expressed as:

$$arg {max}_{𝓎 , 𝓏} {\sum }_{l = 1}^{L} {𝓏}_{β ( l )} \cdot ( {𝓎}_{l}^{T} \cdot {{ˆ}^{}}_{l} ) \\ S . T . \\ {\sum }_{l = 1}^{L} {𝓏}_{β ( l )} \cdot ( {𝓎}_{l} \cdot ( {𝓎}_{l - 1}^{T} \cdot {C}_{l} ) ) \leq Ψ$$

The model pruner 118 can restrict all decision variables [symbol] and [symbol] to binary values, while the layer importance scores [symbol] ₗ and latency cost matrices 114 (represented as Cₗ) can include floating-point values. As described herein, the layer channel variable [symbol] ₗ is a one-hot vector, and therefore the following expression van be formulated as an additional constraint for the MINLP function:

$${𝓎}_{l}^{T} \cdot 1 = 1 , ∀ l ∈ [ 1 , L ]$$

The model pruner 118 can implement any suitable solving technique to solve the MINLP function to determine the optimal decision variables [symbol] and [symbol] . In some implementations, the model pruner 118 can implement a Feasibility Pump (FP) method to improve computational efficiency of the solving the MINLP function. Any suitable MINLP solving technique can be used to determine the optimal decision variables [symbol] and [symbol] , including but not limited to numerical decomposition techniques, branch-and-bound techniques, outer approximation techniques, and branch-and-cut techniques, among others (or combinations thereof).

Once solved, the model pruner 118 can extract a subnetwork from the machine-learning model 104 according to the optimal decision variables [symbol] and [symbol] . If a block decision variable was set to [symbol] _{b}=0 for a given block b, the model pruner 118 can remove that block when generating the pruned subnetwork \hat{Θ} and disregard the corresponding layer channel variables [symbol] ₗ of layers within that block (e.g., where β(l)=b). If a block 106 is indicated as active with [symbol] _{b}=1, and the corresponding layer channel variable

$${𝓎}_{l}^{i} = 1$$

the model number 118 can keep i channels 108 in the lth layer 107 of the pruned subnetwork \hat{Θ}. The i channels 108 selected for inclusion in in the lth layer 107 can be determined according to ArgTopK( [symbol] ₗ, i), which maps the importance scores of [symbol] ₗ back to the i top-performing channels 108.

The model pruner 118 can store the pruned subnetwork (as the pruned machine-learning model 120. Once generated, the model pruner 118 can update/fine-tune the pruned machine-learning model 120 using the training dataset 130. Updating the pruned machine-learning model 120 can include training/updating the pruned machine-learning model 120 according to supervised learning techniques. To fine-tune/update the pruned machine-learning model 120, the model pruner 118 can access the training dataset 130 provide one or more training/update examples as input to the pruned machine-learning model 120. The model pruner 118 can execute the pruned machine-learning model 120 using the training/update example by performing mathematical computations of each layer 107 (e.g., convolutions, activation functions, multiplications by weight values, etc.) and propagating the resulting data to the next layer in the pruned machine-learning model 120.

The output produced by the last layer of the pruned machine-learning model 120 is compared to corresponding ground truth data in the training dataset 130 to calculate/determine an error between the output produced by the pruned machine-learning model 120 and the expected output. The error may be calculated using a suitable loss function. In some implementations, multiple training/updating examples may be provided as input to the pruned machine-learning model 120 and can be compared to multiple corresponding sets of ground truth data to calculate the error using the loss function. The error calculated using the loss function is then utilized to iteratively fine-tune/update the parameters of the pruned machine-learning model 120. The parameters of the pruned machine-learning model 120 may be updated using backpropagation and a suitable optimization algorithm to minimize the error produced by the loss function. In some implementations, the pruned machine-learning model 120 can be trained/updated according to a predetermined number of epochs E.

Once the pruned machine-learning model 120 has been updated/finetuned to recover its accuracy, the data processing system 102 can transmit or otherwise provide the pruned machine-learning model 120 to the target computing environment 122 for execution. The pruned machine-learning model 120 can be executed at the target computing environment 122 to perform processing operations in accordance with the target latency constraint Ψ. As described herein, the pruned machine-learning model 120 may be any type of machine-learning model capable of any type of machine-learning task, including image classification, object detection, or segmentation, among other machine-learning tasks. The target computing environment 122 can be any type of computing device, system, or distributed computing environment. The target computing environment 122 can execute the pruned machine-learning model 120 by providing data to be processed to one or more input layers of the pruned machine-learning model 120, and performing the processing operations of each layer until processed output is generated.

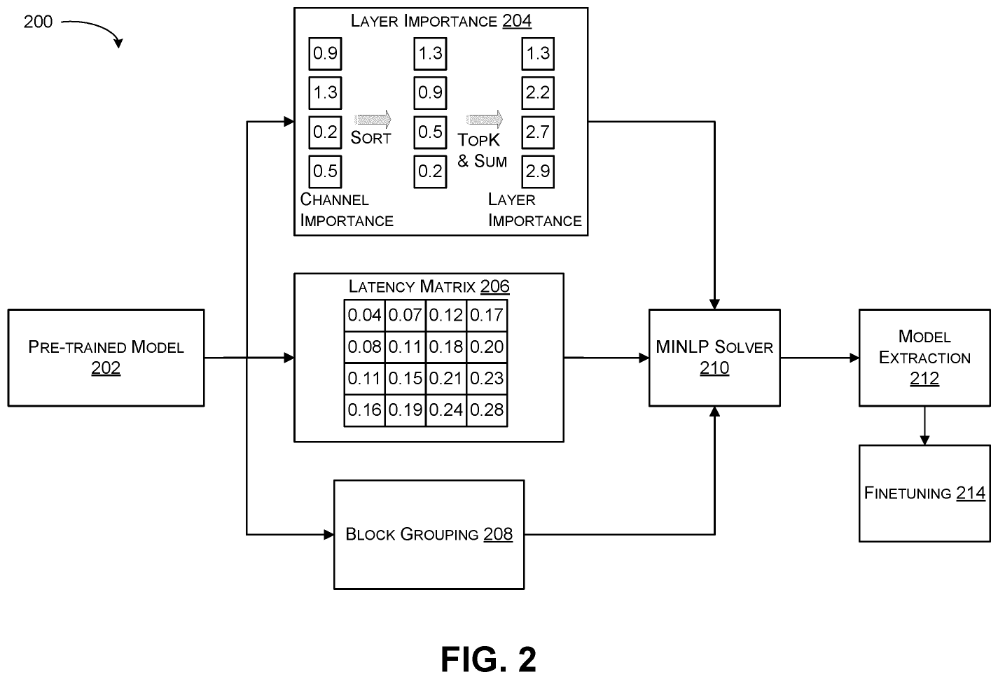

Referring to FIG. 2, illustrated is an example dataflow diagram 200 showing how pruning is jointly performed at the channel, layer, and block level of a pre-trained model 202, in accordance with some embodiments of the present disclosure. As shown, a pre-trained model 202 (e.g., the machine-learning model 104, a neural network, etc.) is pruned by determining layer importance 204 and generating a latency matrix 206 for each layer of the pre-trained model 202 and performing block grouping 208 according to one or more skip connections present in the pre-trained model 202.

In this example, layer importance 204 calculation is shown for a single layer having four (4) input channels and four (4) output channels (e.g., channels 108). The number of output channels corresponds to a number of convolutional filters in the corresponding layer of the pre-trained model 202. As shown, layer importance 204 is calculated by first calculating a set of channel importance scores, which in this example is shown as 0.9, 1.3, 0.2, and 0.5 for the four output channels of the corresponding layer. These values are then sorted according to their magnitude and used to calculate a corresponding set of importance scores for the layer. The first importance score of 1.3, corresponds to the most important channel in the layer (e.g., 1.3), the second importance score of 2.2 corresponds to the sum of the top two most important channels in the layer (e.g., 1.3+0.9), the third importance score of 2.7 corresponds to the sum of the top three most important channels in the layer (e.g., 1.3+0.9+0.5), and the fourth importance score of 2.9 corresponds to the sum of all channels in the layer (e.g., 1.3+0.9+0.5+0.2).

In this example, calculation of the latency matrix 206 is performed for the same single layer having four (4) input channels and four (4) output channels (e.g., channels 108). In this example, a grid of latency values representing the latency matrix 206 is shown. In this example, the first column corresponds to latency values determined at the target environment using a single output channel (e.g., a single filter), the second column is determined using two output channels, the third column is determined using three output channels, and the fourth column is determined using four output channels. Similarly, latency values in the first row are determined at the target environment using a single input channel, latency values in the second row are determined using two input channels, latency values in the third row are determined using three input channels, and latency values in the fourth row are determined using four input channels. As shown, this results in smaller latency values toward the top-left of the latency matrix 206 (e.g., due to fewer input/output channels) and greater latency values toward the bottom-right of the latency matrix 206 (e.g., due to a greater number of input/output channels).

The block grouping process 208, as described herein, is used to group blocks (e.g., the blocks 106) layer channel variables according to layers within residual blocks in the pre-trained model 202. As described herein, layers in a residual block of the pre-trained model 202 can be removed, as he continuity through the network is preserved by the skip connection defining the corresponding block. Block decision variables defined by the block grouping process 208 can have greater priority over layer channel decision blocks, such that blocks pruned according to the techniques described herein prevent consideration of the layer channel variables of the layers within the pruned block.

The MINLP solver 210 can be used to optimize the layer channel decision variables and the block decision variables to arrive at an optimal pruned network (e.g., the pruned machine-learning model 120), as described herein. Any suitable MINLP solving technique can be used to determine the optimal decision variables for pruning the pre-trained model 202, including but not limited to numerical decomposition techniques, branch-and-bound techniques, outer approximation techniques, FP techniques, and branch-and-cut techniques, among others (or combinations thereof). The optimal configuration of the network is then extracted according to the optimal variables determined by the MINLP solver 210 using the model extraction process 212. The model extraction process 212 can be used to select the channels, layers, and blocks that are identified in the optimized layer channel decision variables and block decision variables for inclusion in the pruned subnetwork of the pre-trained model 202. The pruned subnetwork is then updated/finetuned using a finetuning process 214 as described herein to preserve the accuracy of the pruned model.

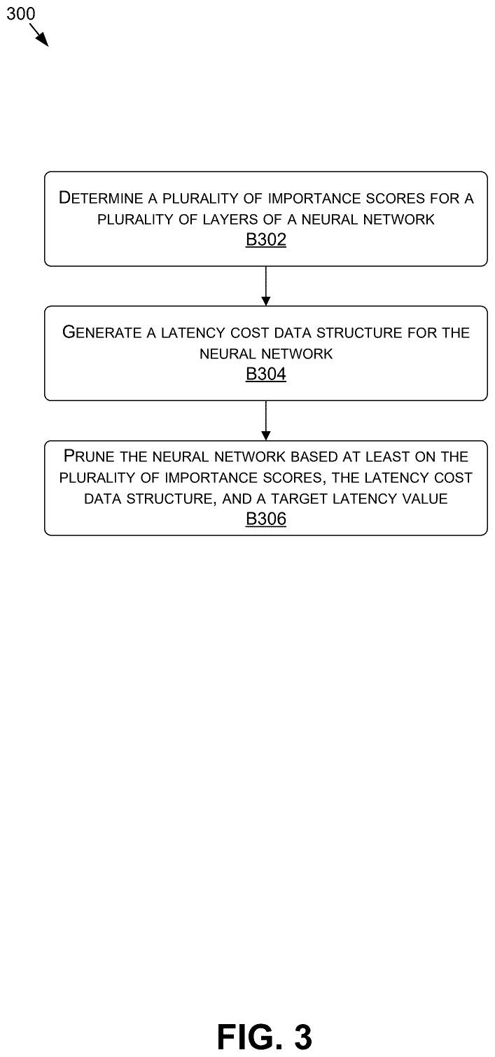

FIG. 3 is a flow diagram showing a method 300 of implementing joint channel, layer, and block pruning for neural networks according to latency constraints, in accordance with some embodiments of the present disclosure. Various operations of the method 300 can be implemented by the same or different devices or entities at various points in time. For example, one or more first devices may implement operations relating to pruning and/or finetuning/updating machine-learning models according to the techniques described herein, and one or more second devices may be used to determine latency values for the pruning process and/or execute pruned machine-learning models.

The method 300, at block B302, includes determining a plurality of importance scores (e.g., the layer importance scores [symbol] ₗ) for a plurality of layers (e.g., the layers 107) of a neural network (e.g., the machine-learning model 104). Determining the importance scores for the layers of the neural network can include performing any of the functionality described in connection with the importance determination process 110 of FIG. 1. To determine a layer importance score for a given layer, channel importance scores can be determined for each output channel in the input network. Channel importance scores can be calculated as a function of the BatchNorm weights and biases of the given and gradients corresponding thereto, which may be determined according to forward/backward propagation of training/update examples of a dataset (e.g., the training dataset 130) used to train/update the neural network. Multiple layer importance scores can be calculated for each layer according to the sum of the results of TopK function of the channel importance scores of the layer. In one example, a vector [symbol] ₗ∈ [symbol] can store the layer importance scores for all possible number of channels present in the lth layer of the neural network, from 1 to mₗ.

The method 300, at block B304, includes generating a latency cost data structure (e.g., the latency cost matrices 114, latency cost matrix 206, etc.) for the neural network. Latency cost data structures can be generated for each layer of the neural network, as described herein. Each latency value (e.g., latency values 124) stored in a latency cost data structure can be a respective latency determined from a target computing environment (e.g., the target environment 122). The latency values can be determined according to each combination of possible input and output channels for a given layer, as described herein. The latency values may be determined, for example, by propagating samples through a given layer of the neural network on the target computing environment while profiling the latency.

The method 300, at block B306, includes pruning the neural network based at least on the plurality of importance scores, the latency cost data structure, and/or a target latency value. The target latency value may be determined, for example, according to a target latency for executing the neural network on the target computing environment. As described herein, pruning the neural network can include solving a MINLP to optimize the layer channel and block decision variables [symbol] and [symbol] . Solving the MINLP can include performing any of the operations described in connection with the model pruner 118 of FIG. 1. The output of the MINLP optimization process can include values for the layer channel and block decision variables [symbol] and [symbol] that indicate channels and blocks that are to be pruned/retained to satisfy the latency constraints of the target environment. As the optimization process is also a function of the layer/channel importance scores, the optimization process keeps layers, channels, and blocks that contribute most to accurate model output.

Once the MINLP has been solved, a pruned neural network (e.g., the pruned machine-learning model 120) can be extracted from the neural network according to the optimal decision variables [symbol] and [symbol] . Layers of blocks that are active can be extracted for inclusion in the in the pruned subnetwork, and layers of blocks that are not active can be omitted from the pruned subnetwork. Likewise, the channels of layers that are marked as being activated can be extracted for inclusion in the pruned subnetwork, and channels marked as not activated (e.g., less importance channels according to the channel importance scores and the layer channel decision variable [symbol] ) can be omitted from the pruned subnetwork.

The pruned subnetwork (e.g., pruned neural network), once generated from the neural network according to the optimal decision variables [symbol] and [symbol] , can be finetuned/updated using a training dataset (e.g., the training dataset 130) to recover accuracy of the model. Finetuning/updating the pruned neural network can include performing supervised training/updating using a predetermined number of epochs of the training dataset. Once finetuned/updated, the pruned neural network can be provided to the target computing environment for execution in various machine-learning processing tasks, including but not limited to object detection, segmentation, or image classification, among others.

### Example Content Streaming System

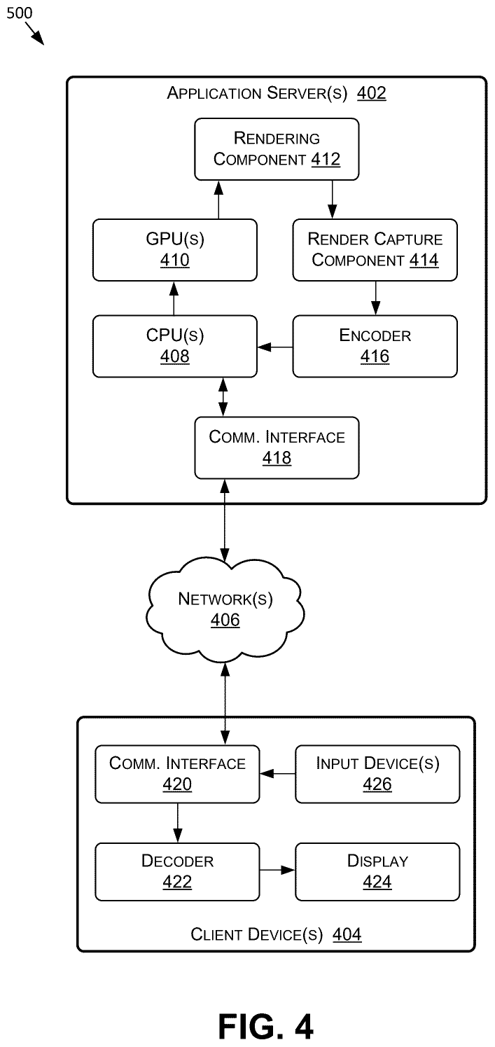

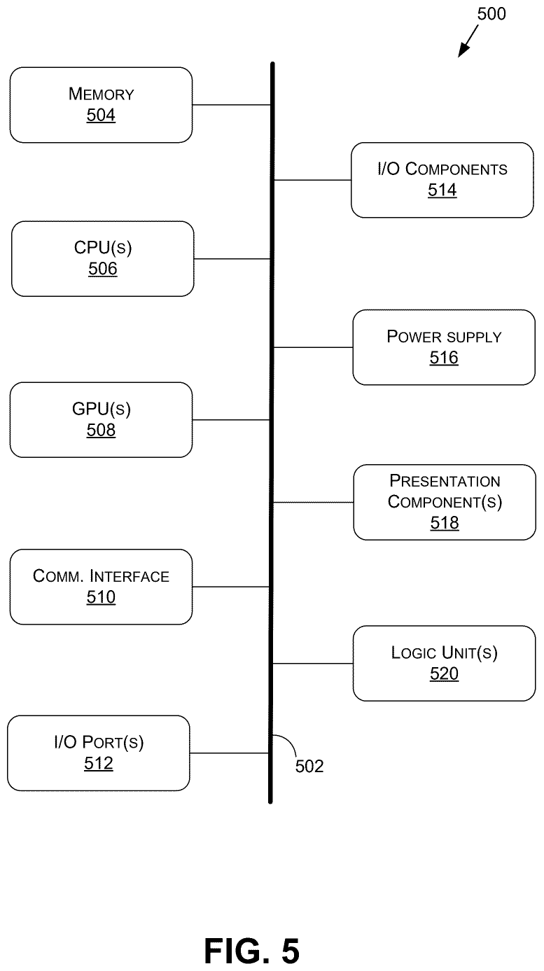

Now referring to FIG. 4, is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to jointly prune neural networks at the block, layer, and channel level, as described herein. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations including display or simulation operations.

In the system 400, for an application session, the client device(s) 404 may only receive input data in response to inputs to the input device(s) 426, transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the application server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based at least on receiving the display data from the application server(s) 402. The client device 404 may receive an input to one of the input device(s) 426 and generate input data in response. The client device 404 may transmit the input data to the application server(s) 402 via the communication interface 420 and over the network(s) 406 (e.g., the Internet), and the application server(s) 402 may receive the input data via the communication interface 418. The CPU(s) 408 may receive the input data, process the input data, and transmit data to the GPU(s) 410 that causes the GPU(s) 410 to generate a rendering of the application session. For example, the input data may be representative of a movement of a character of the user in a game session of a game application, firing a weapon, reloading, passing a ball, turning on a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU 508 may include its own memory or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, including wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

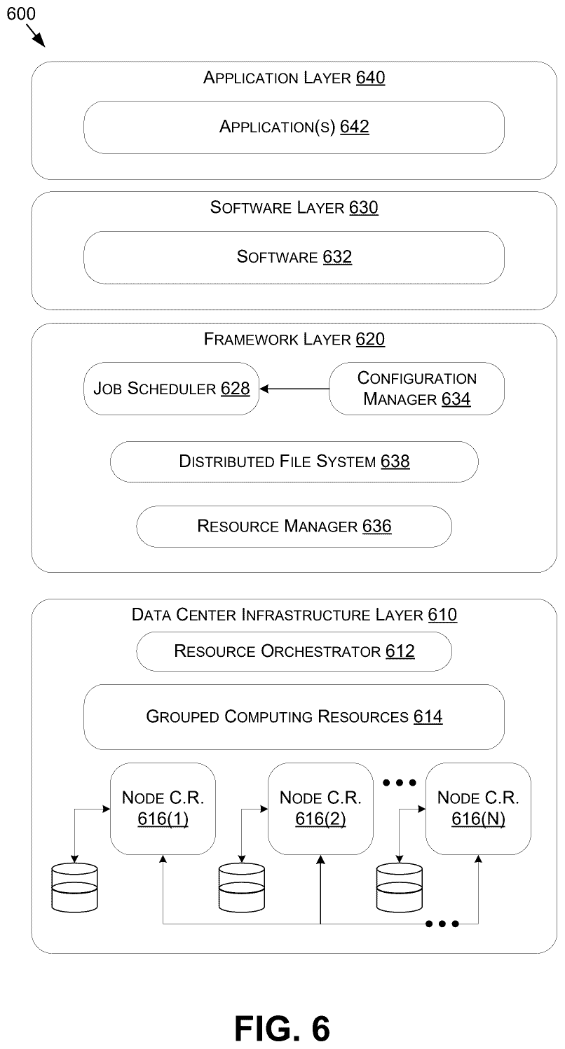

FIG. 6 illustrates an example data center 600 that may be used in at least one embodiments of the present disclosure, such as to implement the system 100 or in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory, or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more embodiments, such as to update/train machine-learning models (e.g., the machine-learning model 104, the pruned machine-learning model 120, etc.).

In at least one embodiment, any of configuration manager 634, resource manager 636, and resource orchestrator 612 may implement any number and type of self-modifying actions based at least on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software, or other resources to update/train one or more machine-learning models (e.g., the machine-learning model 104, the pruned machine-learning model 120, etc.) or predict or infer information according to one or more embodiments described herein. For example, a machine-learning model(s) may be updated/trained by calculating weight parameters according to a neural network architecture using software and/or computing resources described above with respect to the data center 600. In at least one embodiment, trained or deployed machine-learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
determine a plurality of importance scores for a plurality of layers of a neural network;
generate a latency cost data structure for the neural network; and
prune the neural network based at least on the plurality of importance scores, the latency cost data structure, and a target latency value.

2. The one or more processors of claim 1, wherein the one or more circuits are to:
extract a subnetwork from the neural network based at least on the plurality of importance scores and the latency cost data structure; and
generate a pruned neural network by updating the subnetwork using a training dataset.

3. The one or more processors of claim 1, wherein the one or more circuits are to:
identify at least one block of a subset of the plurality of layers of the neural network; and
prune the at least one block from the neural network based at least on the plurality of importance scores and the latency cost data structure.

4. The one or more processors of claim 1, wherein the one or more circuits are to:
identify at least one channel of at least one layer of the plurality of layers of the neural network; and
prune the at least one channel from the neural network based at least on the plurality of importance scores and the latency cost data structure.

5. The one or more processors of claim 3, wherein the one or more circuits are to:
identify the subset of the plurality of layers based at least on a skip connection of the neural network.

6. The one or more processors of claim 1, wherein the one or more circuits are to:
generate a respective set of channel importance scores for each layer of the plurality of layers; and
generate the plurality of importance scores based at least on the respective set of channel importance scores for each layer of the plurality of layers.

7. The one or more processors of claim 1, wherein the one or more circuits are to:
determine a respective latency of each channel of a layer of the plurality of layers; and
generate the latency cost data structure based at least on the respective latency of each channel.

8. The one or more processors of claim 1, wherein the one or more circuits are to:
identify one or more layers or one or more blocks of the neural network to prune using a mixed-integer non-linear programming (MINLP) optimization function.

9. The one or more processors of claim 6, wherein the one or more circuits are to:
assign each of the one or more layers and the one or more blocks to a respective variable for the MINLP optimization function.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations;
a system implemented using one or more large language models (LLMs);
a system implemented using one or more vision language models (VLMs);
a system implemented using one or more multi-modal language models;
a system for generating synthetic data;
a system incorporating one or more virtual machines (VMs);
a system implemented at least partially in a data center; or
a system implemented at least partially using cloud computing resources.

11. A system, comprising;
one or more processors to:
identify a neural network comprising a plurality of channels, a plurality of layers, and a plurality of blocks;
extract, from the neural network, a subnetwork by jointly pruning at least one block, channel, and layer of the neural network according to a latency constraint; and
update the subnetwork according to a dataset associated with the neural network.

12. The system of claim 11, wherein the one or more processors are further configured to:
determine the latency constraint based at least on a computing environment in which the subnetwork is to be deployed; and
transmit the subnetwork to the computing environment.

13. The system of claim 11, wherein the dataset comprises one or more training examples used to update the neural network.

14. The system of claim 11, wherein the one or more processors are further configured to:
prune the neural network using a mixed-integer non-linear programming (MINLP) optimization function.

15. The system of claim 11, wherein the one or more processors are further configured to:
identify the at least one block based on a skip connection of the neural network.

16. The system of claim 11, wherein the one or more processors are further configured to:
generate a plurality of importance scores for at least the plurality of channels of the neural network; and
prune the neural network further based at least on the plurality of importance scores.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations;
a system implemented using one or more large language models (LLMs);
a system implemented using one or more vision language models (VLMs);
a system implemented using one or more multi-modal language models;
a system for generating synthetic data;
a system incorporating one or more virtual machines (VMs);
a system implemented at least partially in a data center; or
a system implemented at least partially using cloud computing resources.

18. A computing device, comprising:
one or more processors configured to:
identify a processing operation corresponding to a neural network; and
perform the processing operation using a pruned subnetwork, the pruned subnetwork having been extracted from the neural network according to a joint channel, layer, and block pruning process.

19. The computing device of claim 18, wherein the one or more processors are further configured to generate a plurality of latency values for at least a subset of layers of the neural network.

20. The computing device of claim 19, wherein the one or more processors are further configured to generate a lookup table according to the plurality of latency values, wherein the subnetwork is extracted based at least on the lookup table.
